(19) United States
(12) Patent Application Publication
(10) Pub. No.: US 2026/0129346 A1
(43) Pub. Date: May 7, 2026

(54) EARPHONE

(71) Applicant: SHENZHEN SHOKZ CO., LTD., Shenzhen (CN)

(72) Inventors: Guolin XIE, Shenzhen (CN); Chaowu LI, Shenzhen (CN); Qianwen NIE, Shenzhen (CN)

(73) Assignee: SHENZHEN SHOKZ CO., LTD., Shenzhen (CN)

(21) Appl. No.: 19/433,947

(22) Filed: Dec. 28, 2025

Related U.S. Application Data
(63) Continuation of application No. PCT/CN2024/114011, filed on Aug. 22, 2024.

(51) Int. Cl. H04R 1/10; H04R 1/08; H04R 1/34

(52) U.S. Cl. CPC H04R 1/1075; H04R 1/086; H04R 1/1008; H04R 1/105; H04R 1/342

(57) ABSTRACT

Provided is an earphone, the earphone includes: an ear hook and a sound producer connected to each other. The ear hook is hung between an auricle and the head of a user, the sound producer is located at a front side of the auricle, the sound producer includes a core housing and a microphone disposed inside the core housing, the core housing has a connection end connected to the ear hook and a free end away from the connection end, in a wearing state, the connection end is closer to the mouth of the user than the free end, a sound pickup hole is formed on the core housing, the microphone collects sound outside the earphone through the sound pickup hole, and a sound output end of the sound pickup hole is disposed closer to the connection end than a sound input end of the sound pickup hole.

### TECHNICAL FIELD

The present disclosure relates to the field of electronic devices, and in particular to an earphone.

### BACKGROUND

With the continuous popularization of electronic devices, electronic devices have become an indispensable tool for social interaction and entertainment in the daily lives of people. People have increasingly higher requirements for electronic devices. Electronic devices such as earphones and smart glasses have also been widely used in the daily lives of people. They can be used in conjunction with terminal devices such as mobile phones and computers to provide users with an auditory feast.

However, the sound pickup effects of the microphone structures in the traditional earphones are poor. In addition, as application scenarios of earphones become more complex, requirements for wind noise reduction capabilities of earphones are also increasing, therefore making the current sound pickup effects of earphones unable to satisfy the needs of users.

### SUMMARY

To solve the above technical problem, one technical solution adopted by the present disclosure is to provide an earphone. The earphone includes an ear hook and a sound producer connected to each other, the ear hook is hung between an auricle and the head of a user, the sound producer is located at a front side of the auricle, the sound producer includes a core housing and a microphone, the ear hook is connected to the core housing, the microphone is disposed inside the core housing, the core housing has a connection end connected to the ear hook and a free end away from the connection end, in a wearing state, the connection end is closer to the mouth of the user than the free end, a sound pickup hole is formed on the core housing and located between the free end and the connection end, the microphone collects sound outside the earphone through the sound pickup hole, and a sound output end of the sound pickup hole is disposed closer to the connection end than a sound input end of the sound pickup hole.

In some embodiments, the core housing has a length direction and a thickness direction orthogonal to each other, the length direction is an interval direction between the connection end and the free end, the thickness direction is a direction toward or away from the auricle in the wearing state, and at least a portion of a hole section of the sound pickup hole is inclined relative to the length direction and the thickness direction.

In some embodiments, the core housing includes a first sidewall and a second sidewall spaced apart along the thickness direction, the second sidewall is closer to the auricle than the first sidewall in the wearing state, the sound pickup hole is disposed on the first sidewall, and an extension direction of at least a portion of the hole section of the sound pickup hole has an inclination angle relative to the thickness direction greater than 0° and less than or equal to 40°.

In some embodiments, a count of the sound pickup hole corresponds to a count of the microphone, along an extension direction of a line connecting a center of the sound output end and a center of the sound input end, a cross-sectional area of the sound pickup hole is uniform, and the inclination angle is in a range of 10° to 30°.

In some embodiments, the earphone further includes a composite sound resistance mesh disposed between the sound output end of the sound pickup hole and the microphone, the composite sound resistance mesh includes at least two sub sound resistance meshes stacked and spaced apart from each other, and sound input through the sound pickup hole sequentially passes through the at least two sub sound resistance meshes and then is input to the microphone.

In some embodiments, a spacing distance between adjacent sub sound resistance meshes is in a range of 0.05 mm to 0.3 mm, and/or a sound resistance of each of the at least two sub sound resistance meshes is in a range of 200 MKS Rayls to 700 MKS Rayls.

In some embodiments, a count of the sound pickup hole corresponds to a count of the microphone, and a sound pickup area of the microphone is disposed closer to the connection end than the sound output end of the sound pickup hole.

In some embodiments, along the length direction, a spacing distance between a sound pickup area of the microphone and the sound output end of the sound pickup hole is in a range of 2 mm to 3 mm.

In some embodiments, an inner wall of the core housing has an annular partition plate, the annular partition plate surrounds to form a connecting groove, and the sound pickup hole communicates with the connecting groove; and the earphone includes a circuit board and a sound guiding seat, the sound guiding seat is disposed on a side of the circuit board facing the connecting groove and is provided with a sound guiding channel, the sound guiding seat is embedded in the connecting groove under a supporting effect of the circuit board and presses the composite sound resistance mesh between the sound guiding seat and the core housing, the microphone is disposed on another side of the circuit board away from the connecting groove, a connecting hole is provided on the circuit board, and the microphone communicates with the sound pickup hole through the connecting hole and the sound guiding channel.

In some embodiments, the core housing has a length direction, a thickness direction, and a width direction orthogonal to each other, the length direction is an interval direction between the connection end and the free end, the thickness direction is a direction toward or away from the auricle in the wearing state, the core housing includes a first housing and a second housing, the first housing and the second housing are fitted to each other along the thickness direction and form a first joint seam, in the wearing state, the first housing is farther from the auricle than the second housing, the ear hook includes a transition portion, the transition portion is connected to the second housing and forms a second joint seam, at least one mounting slot in an elongated shape is provided on an outer surface of the second housing, and the first joint seam, a major axis direction of the at least one mounting slot, and the second joint seam are inclined in a same direction relative to the length direction.

In some embodiments, the first housing has a first sidewall, the second housing has a second sidewall, the first sidewall and the second sidewall are spaced apart along the thickness direction, the second sidewall is closer to the auricle than the first sidewall in the wearing state, and the first joint seam, the major axis direction of the at least one mounting slot, and the second joint seam are gradually away from the second sidewall along a direction from the free end toward the connection end.

In some embodiments, a minimum spacing distance between a slot edge of the at least one mounting slot and the first joint seam is in a range of 1 mm to 2 mm; and/or a minimum spacing distance between the slot edge of the at least one mounting slot and the second joint seam is in a range of 1 mm to 2 mm.

In some embodiments, the earphone further includes a speaker assembly disposed inside the core housing, the speaker assembly and the core housing form an acoustic front cavity and an acoustic rear cavity, a pressure relief hole is further provided on the second housing and located in the at least one mounting slot, the pressure relief hole communicates with the acoustic rear cavity, an acoustic mesh is disposed in the at least one mounting slot and covers the pressure relief hole, and a ratio of an area of the pressure relief hole to an area of the at least one mounting slot is in a range of 0.2 to 0.7.

The beneficial effects of the present disclosure are as follows. The earphone described in the present disclosure is provided with the core housing. The core housing is provided with the free end and the connection end. In the wearing state, the connection end of the earphone is closer to the mouth of the user than the free end. When the user moves forward, such as walking, running, or cycling, the airflow near the earphone typically flows from the connection end toward the free end. Therefore, the sound input end of the sound pickup hole is disposed closer to the free end than the sound output end of the sound pickup hole. The line connecting the sound output end and the sound input end of the sound pickup hole can intersect a sagittal axis of the human body and form an acute angle with the sagittal axis in a direction from the front of the human body toward the rear of the human body. Simultaneously, the sound output end is closer to the sagittal axis of the human body than the sound input end, so that the sound pickup hole is disposed inclined toward a rear side of the head of the user relative to a side of the mouth of the user. When airflow flowing from the connection end toward the free end enters the sound pickup hole at the sound input end, the airflow is first blocked by a hole wall of the sound pickup hole and then further enters the sound pickup hole, flowing toward the sound output end. The blocking of the airflow by the hole wall of the sound pickup hole prevents the airflow from flowing directly toward the sound output end, and the impact level of the airflow on the microphone is reduced during the blocking process by the hole wall of the sound pickup hole. Therefore, the arrangement where the sound input end of the sound pickup hole is closer to the free end than the sound output end can reduce the impact force of airflow on the microphone in the wearing state, thereby improving the anti-wind-noise capability of the earphone and effectively enhancing the sound pickup effect of the microphone.

### BRIEF DESCRIPTION OF THE DRAWINGS

FIG. 1 is a schematic diagram illustrating an anterior contour of an auricle of a user according to the present disclosure;

FIG. 2 is a schematic diagram illustrating a three-dimensional structure of one side of an earphone according to some embodiments of the present disclosure;

FIG. 3 is a schematic diagram illustrating the earphone shown in FIG. 2 in a wearing state;

FIG. 4 is a schematic diagram illustrating a three-dimensional structure of one side of a sound producer in the earphone shown in FIG. 2;

FIG. 5 is a schematic diagram illustrating an exploded structure of the sound producer shown in FIG. 4;

FIG. 6 is a schematic diagram illustrating a cross-sectional structure along a section line A-A of the sound producer shown in FIG. 4;

FIG. 7 is a schematic diagram illustrating an enlarged view of a partial area B of the sound producer shown in FIG. 6;

FIG. 8 is a schematic comparison diagram of effects when an extension direction of at least a portion of a hole section of a sound pickup hole in an earphone is inclined at different angles relative to a thickness direction according to some embodiments of the present disclosure;

FIG. 9 is a schematic diagram illustrating structures of a portion of components in the sound producer shown in FIG. 5;

FIG. 10 is a schematic diagram illustrating an effect of setting a single-layer sub sound resistance mesh and an effect of setting a double-layer sub sound resistance mesh in an earphone according to some embodiments of the present disclosure.

FIG. 11 is a schematic diagram illustrating another side of the sound producer in the earphone shown in FIG. 2; and

FIG. 12 is a schematic diagram illustrating a three-dimensional structure of another side of the earphone shown in FIG. 2.

### DETAILED DESCRIPTION

The technical solutions in the embodiments of the present disclosure are clearly and completely described below with reference to the accompanying drawings in the embodiments of the present disclosure. It is apparent that the described embodiments are only a part of the embodiments of the present disclosure, rather than all the embodiments. Based on the embodiments of the present disclosure, all other embodiments obtained by a person of ordinary skill in the art without creative efforts fall within the scope of protection of the present disclosure.

The mention of “embodiment” in the present disclosure means that a specific feature, structure, or characteristic described in connection with the embodiment may be included in at least one embodiment of the present disclosure. A person skilled in the art explicitly and implicitly understands that the embodiments described in the present disclosure may be combined with other embodiments.

The following is an exemplary description of an earphone in an earphone embodiment.

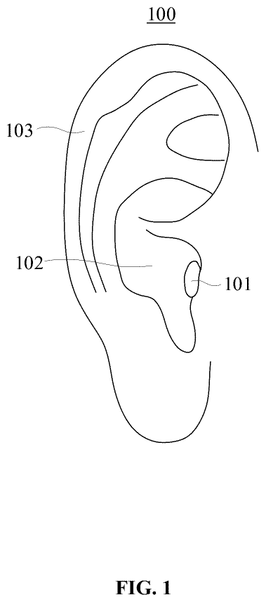

With reference to FIG. 1, an ear 100 of a user may include physiological parts such as an external auditory canal 101, a concha cavity 102, and an auricle 103. Although the external auditory canal 101 has a certain depth and extends to the tympanic membrane of the ear 100, for ease of description, the external auditory canal 101 in the present disclosure specifically refers to an entrance (i.e., an ear hole) thereof facing away from the tympanic membrane unless otherwise specified. In addition, the concha cavity 102 has a certain volume and depth, and the concha cavity 102 is directly connected to the external auditory canal 101. That is, the aforementioned ear hole may be simply regarded as being located at a bottom of the concha cavity 102.

An earphone 1 refers to an audio converter capable of receiving an electrical signal from a media player or a receiver and converting the electrical signal into a sound wave that may be heard by a user. In some embodiments, the earphone 1 may be an open earphone, for example, an ear hook earphone, a behind-the-neck earphone, or an ear clip earphone.

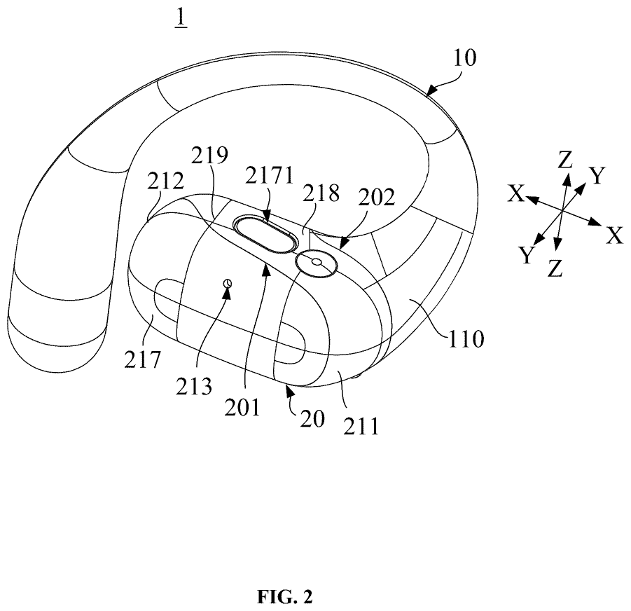

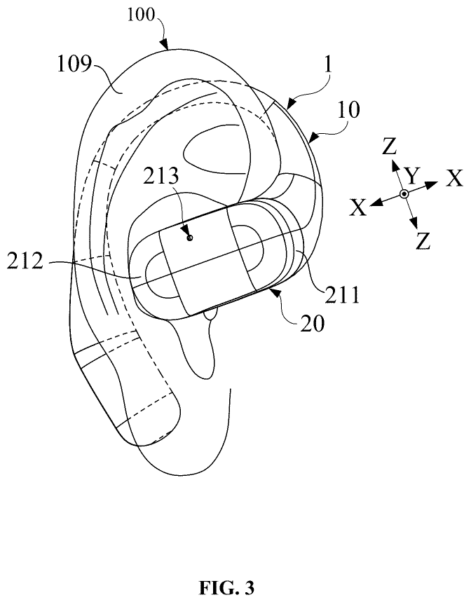

As shown in FIG. 2 or FIG. 3, the earphone 1 may be the ear hook earphone. In some embodiments, in a wearing state, at least a portion of the earphone 1 may be inserted into the concha cavity 102 of the user to improve wearing stability. In some embodiments, at least a portion of a sound producer of the earphone 1 may cover an auricle 103 of an ear of the user, such as positions (not shown in figures) of an antihelix, a cymba conchae, a triangular fossa, etc., but does not block the external auditory canal 101 of the ear of the user or visually block the external auditory canal 101 of the ear of the user. In some embodiments, a sound producer 20 of the earphone 1 may also fit against or abut a facial area in front of the ear of the user, a side of the sound producer 20 for producing sound faces the ear of the user, or faces the external auditory canal 101 of the user.

Furthermore, different users may have individual differences, resulting in dimensional differences in the ear 100, such as different shapes and sizes. For ease of description and to reduce or even eliminate the individual differences of different users, a simulator including a head and ears 100 (left and right) of the head may be manufactured based on ANSI: S3.36, S3.25 and IEC: 60318-7 standards, such as series of GRAS 45BC KEMAR, HEAD Acoustics, B&K 4128, or B&K 5128, to present a scenario where most users wear the earphone 1. Merely by way of example, GRAS KEMAR is used as an example, the simulator of the ear 100 may be any one of GRAS 45AC, GRAS 45BC, GRAS 45CC, or GRAS 43AG. HEAD Acoustics is used as an example, the simulator of the ear 100 may be any one of HMS II.3, HMS II.3 LN, or HMS II.3LN HEC. Therefore, in the present disclosure, descriptions such as “a user wears the earphone 1”, “the earphone 1 is in a wearing state”, and “in a wearing state” may refer to the earphone 1 described in the present disclosure being worn on the ear 100 of the aforementioned simulator. Certainly, precisely because the different users have individual differences, certain differences may exist when the earphone 1 is worn by different users compared to when the earphone 1 is worn on the ear 100 of the aforementioned simulator. However, such differences should be tolerated.

It should be noted that in fields such as medicine and anatomy, three basic planes and three basic axes may be defined for a human body or a human body simulator: a sagittal plane, a coronal plane, a horizontal plane, a sagittal axis, a coronal axis, and a vertical axis. The sagittal plane refers to a vertical section made along the anteroposterior direction of the body, which divides the human body or human body simulator into left and right portions. The coronal plane refers to a vertical section made along the left-right direction of the body, which divides the human body or human body simulator into front and rear portions. The horizontal plane refers to a horizontal section made along the superior-inferior direction of the body, which divides the human body or human body simulator into upper and lower portions. Correspondingly, the sagittal axis refers to an axis along the anteroposterior direction of the body and perpendicular to the coronal plane. The coronal axis refers to an axis along the left-right direction of the body and perpendicular to the sagittal plane. The vertical axis refers to an axis along the superior-inferior direction of the body and perpendicular to the horizontal plane. Furthermore, the “front side of the ear” described in the present disclosure is a concept relative to the “rear side of the ear”. The former refers to a side of the ear facing away from the head, and the latter refers to a side of the ear facing toward the head. Both the former and the latter are defined with respect to the ear 100 of the user or the simulator. When observing the ear 100 of the human body or the human body simulator along a direction of the coronal axis, it may be as shown in FIG. 1.

Merely by way of example, with reference to FIG. 2 and FIG. 3, the earphone 1 may include an ear hook 10 and the sound producer 20 connected to each other. In the wearing state, the ear hook 10 may be hung between the auricle 103 and the head of the user. That is, at least a portion of the ear hook 10 of the earphone 1 may be located at the rear side of the ear 100, so that the earphone 1 is hung on the ear 100, and the sound producer 20 may be located at a front side of the auricle 103. The sound producer 20 may be a sound playback device. The sound producer 20 may be configured to convert an electrical signal into a sound signal (also referred to as “sound waves” or “audio signals”) and propagate the sound signal to the ear 100 of a wearer.

In some embodiments, a component, such as a battery or a circuit board, may be disposed inside the ear hook 10, or both the battery and the circuit board may be disposed in the ear hook 10. Certainly, the ear hook 10 may not be provided with components such as the battery and the circuit board, and the battery and the circuit board may be installed in the sound producer 20.

As shown in FIG. 2 to FIG. 5, the sound producer 20 may include a core housing 210 and a microphone 220. The ear hook 10 may be connected to the core housing 210, and the microphone 220 may be disposed inside the core housing 210. In some embodiments, the earphone 1 may further include a speaker assembly 30 disposed inside the core housing 210. The speaker assembly 30 refers to a component capable of converting the electrical signal into a corresponding sound signal to implement a sound playback function of the sound producer 20. Merely by way of example, the speaker assembly 30 may include a bone conduction speaker and an air conduction speaker. In other embodiments, the speaker assembly 30 may also be set to only one of the air conduction speaker and the bone conduction speaker.

In some embodiments, as shown in FIG. 2 and FIG. 3, the core housing 210 may have a connection end 211 connected to the ear hook 10 and a free end 212 away from the connection end 211. In the wearing state, the connection end 211 is closer to the mouth of the user than the free end 212. In other words, in the wearing state, the free end 212 of the earphone 1 is closer to a rear side of the head of the user than the connection end 211 connected to the ear hook 10.

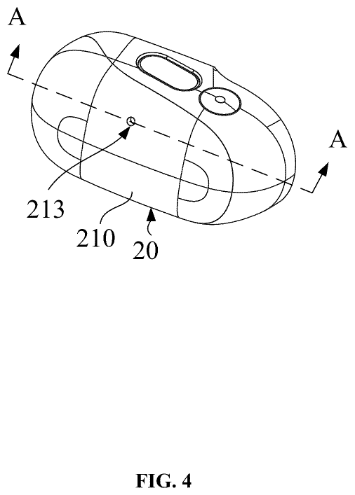

In some embodiments, as shown in FIG. 4 to FIG. 7, a sound pickup hole 213 may be provided on the core housing 210 between the free end 212 and the connection end 211. The microphone 220 collects sound outside the earphone 1 through the sound pickup hole 213. The sound outside the earphone 1 may be a speech of the user, a horn sound, a bicycle bell sound, a surrounding human voice, a traffic command sound, or the like.

In some embodiments, a sound output end 2131 of the sound pickup hole 213 may be disposed closer to the connection end 211 than a sound input end 2132 of the sound pickup hole 213. The sound input end 2132 of the sound pickup hole 213 refers to an end of the sound pickup hole 213 facing an outside of the core housing 210, and the sound outside the earphone 1 enters the sound pickup hole 213 from the sound input end 2132. The sound output end 2131 of the sound pickup hole 213 refers to an end of the sound pickup hole 213 facing an inside of the core housing 210. After the sound enters the sound pickup hole 213 from the sound input end 2132, the sound enters the inside of the core housing 210 from the sound output end 2131 to be collected by the microphone 220.

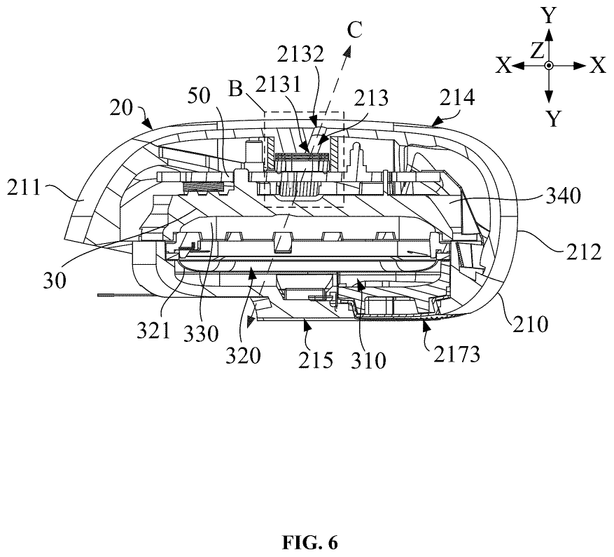

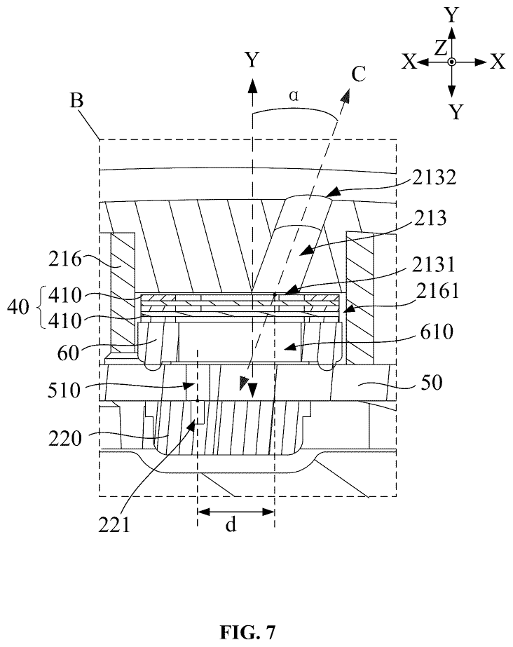

Merely by way of example, a direction of a line connecting a center of the sound output end 2131 of the sound pickup hole 213 and a center of the sound input end 2132 of the sound pickup hole 213 may intersect a sagittal axis of a human body and form an acute angle with the sagittal axis in a direction from a front of the human body to a rear of the human body. Simultaneously, the sound output end 2131 is closer to the sagittal axis of the human body than the sound input end 2132, so that the sound pickup hole 213 is arranged to be inclined toward the rear side of the head of the user relative to a side of the mouth of the user. The direction of the line between the sound output end 2131 and the sound input end 2132 of the sound pickup hole 213 may be as shown by a direction of an arrow C in FIG. 6 and FIG. 7.

In the wearing state, the connection end 211 of the earphone 1 is closer to the mouth of the user than the free end 212. Therefore, when the user moves forward, such as walking, running, or cycling, an airflow near the earphone 1 usually flows from the connection end 211 to the free end 212. Therefore, the sound input end 2132 of the sound pickup hole 213 is disposed closer to the free end 212 than the sound output end 2131 of the sound pickup hole 213, which causes the line between the sound output end 2131 and the sound input end 2132 of the sound pickup hole 213 to intersect the sagittal axis of the human body and form the acute angle with the sagittal axis in the direction from the front of the human body to the rear of the human body, and the sound output end 2131 is closer to the sagittal axis of the human body than the sound input end 2132. When the airflow flowing from the connection end 211 to the free end 212 flows into the sound pickup hole 213 at the sound input end 2132, the airflow is first blocked by a hole wall of the sound pickup hole 213 and then further enters the sound pickup hole 213, flowing toward the sound output end 2131. The blocking of the airflow by the hole wall of the sound pickup hole 213 prevents the airflow from directly entering the sound pickup hole 213. An impact degree of the airflow on the microphone 220 is reduced during the blocking of the airflow by the hole wall of the sound pickup hole 213. The arrangement where the sound input end 2132 of the sound pickup hole 213 is closer to the free end 212 than the sound output end 2131 can reduce an impact force of the airflow on the microphone 220 in the wearing state, thereby improving the anti-wind-noise capability of the earphone 1 and effectively improving the sound pickup effect of the microphone 220.

In some embodiments, the core housing 210 may have a length direction, a thickness direction, and a width direction orthogonal to each other. The length direction may be an interval direction between the connection end 211 and the free end 212. The interval direction of the connection end 211 and the free end 212 refers to an extension direction of a connection line between the connection end 211 and the free end 212. In some embodiments, the connection end 211 and the free end 212 may have an irregular or regular arc shape. The extension direction of the connection line between the connection end 211 and the free end 212 refers to a direction defined by a straight line perpendicular to parallel tangent planes of two reference points on the connection end 211 and the free end 212 that are farthest apart from each other. The length direction may also be defined as a direction in which the core housing 210 approaches or moves away from the back of the head in the wearing state. In other words, the length direction may be a direction indicated by a direction of an arrow X in FIG. 2 to FIG. 7.

The thickness direction may be a direction in which the earphone 1 faces toward or away from the auricle 103 in the wearing state. The thickness direction may be a direction indicated by a direction of an arrow Y in FIG. 2 to FIG. 7. The thickness direction may be substantially parallel to a vibration direction of the speaker assembly 30. Substantially parallel means that a spatial angle between the thickness direction and the vibration direction is less than 5°.

The width direction may be defined as a direction in which the core housing 210 approaches or moves away from the top of the head in the wearing state. The width direction may be a direction indicated by a direction of an arrow Z in FIG. 2 to FIG. 7.

In some embodiments, at least a portion of a hole section of the sound pickup hole 213 may be inclined relative to the length direction X and the thickness direction Y. With such an arrangement, the sound output end 2131 of the sound pickup hole 213 may be arranged closer to the connection end 211 than the sound input end 2132 of the sound pickup hole 213. Thus, in the wearing state, when an external airflow enters the sound pickup hole 213 from the sound input end 2132 and flows toward the sound output end 2131, the airflow is blocked by the at least partially inclined hole section and does not directly flow to the sound output end 2131 to impact the microphone 220. This can reduce the impact force of the airflow on the microphone 220 in the wearing state, thereby improving the anti-wind-noise capability of the earphone 1 and effectively enhancing the sound pickup effect of the microphone 220.

In some embodiments, a cross-sectional area of the sound output end 2131 of the sound pickup hole 213 and a cross-sectional area of the sound input end 2132 of the sound pickup hole 213 may be uniform.

In some embodiments, as shown in FIG. 7, along the extension direction of a connection line between the center of the sound output end 2131 and the center of the sound input end 2132, a cross-sectional area of the sound pickup hole 213 may be uniform. The entire sound pickup hole 213 may be inclined relative to the length direction X and the thickness direction Y. Setting the cross-sectional area of the sound pickup hole 213 to be uniform along the extension direction of the connection line between the center of the sound output end 2131 and the center of the sound input end 2132 can enable the hole wall of the sound pickup hole 213 to block most of the airflow to reduce wind noise when an external sound passes through the sound pickup hole 213. Setting the cross-sectional area of the sound pickup hole 213 to be uniform along the extension direction of the connection line between the center of the sound output end 2131 and the center of the sound input end 2132 can also reduce attenuation of effective sound information by the sound pickup hole 213, thereby ensuring the sound pickup effect and the anti-wind-noise effect of the microphone 220.

In some embodiments, the effective sound information refers to target information, such as call voice information or warning information. In some embodiments, the effective sound information refers to target frequency band sound information, e.g., sound information in frequency bands of 500 Hz to 1 kHz, 1 kHz to 2 kHz, or 200 Hz to 2 kHz.

In some embodiments, to ensure the anti-wind-noise effect of the sound pickup hole 213, an inclination angle of the extension direction of all hole section of the sound pickup hole 213 relative to the thickness direction Y may be in a range of 0° to 40°. In some embodiments, to further improve the anti-wind-noise effect of the sound pickup hole 213, the inclination angle of the extension direction of all hole section of the sound pickup hole 213 relative to the thickness direction Y may be in a range of 10° to 20°.

In some embodiments, a portion of the hole section of the sound pickup hole 213 may be arranged in an inclined manner, and other portions of the hole section may be arranged in a curved shape to adapt to an internal structure of the core housing 210, so that the curved hole section can avoid other components inside the core housing 210. Such an arrangement can further enhance the anti-wind-noise effect of the sound pickup hole 213. In some embodiments, to further reduce an impact of wind noise, the entire sound pickup hole 213 may be arranged in an arc shape.

In some embodiments, the sound pickup hole 213 may be arranged with a plurality of bends, so that the sound output end 2131 of the sound pickup hole 213 is arranged closer to the connection end 211 than the sound input end 2132 of the sound pickup hole 213, while avoiding other electronic components installed inside the core housing 210 and preventing the core housing 210 from having an excessively large size.

In some embodiments, as shown in FIG. 6 and FIG. 7, the core housing 210 may include a first sidewall 214 and a second sidewall 215 spaced apart along the thickness direction Y. The second sidewall 215 is closer to the auricle 103 than the first sidewall 214 in the wearing state. The sound pickup hole 213 may be disposed on the first sidewall 214, and the inclination angle of the extension direction of the at least a portion of the hole section of the sound pickup hole 213 relative to the thickness direction Y is greater than 0° and less than or equal to 40°. Merely by way of example, the extension direction of the at least a portion of the hole section of the sound pickup hole 213 may be as shown by a direction of an arrow C in FIG. 7. The inclination angle of the extension direction of the at least a portion of the hole section of the sound pickup hole 213 relative to the thickness direction Y may be as shown by an angle α in FIG. 7.

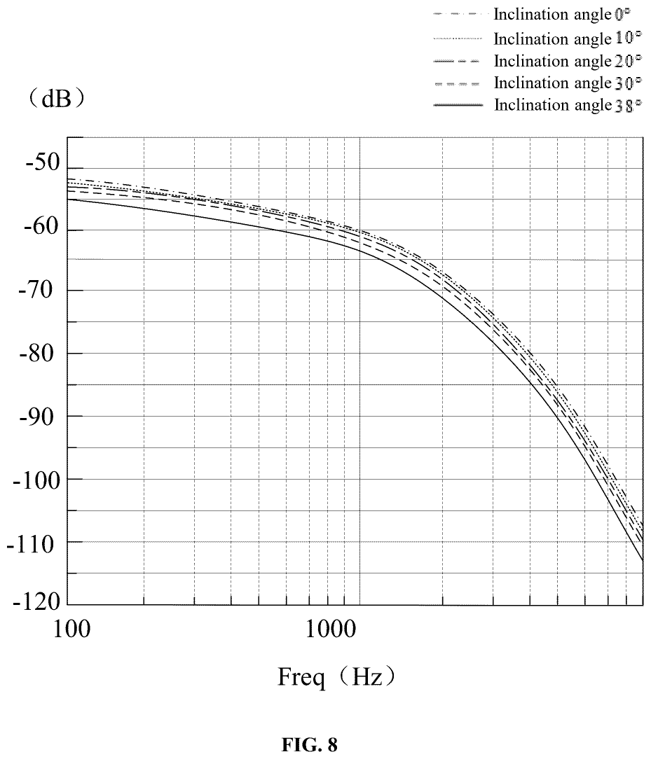

As shown in FIG. 8, FIG. 8 shows a comparison of effects under same conditions when the extension direction of the at least a portion of the hole section of the sound pickup hole 213 is inclined at different angles relative to the thickness direction Y. All other conditions are the same except for an inclination angle α of the hole section. As shown in FIG. 8, a wind noise decibel collected by the microphone 220 gradually decreases as the inclination angle α increases. For example, when the inclination angle α of the extension direction of the at least a portion of the hole section of the sound pickup hole 213 relative to the thickness direction Y is 10°, the wind noise decibel collected by the microphone 220 is lower than the wind noise decibel when the inclination angle α is 0°. When the inclination angle α is 30°, the wind noise decibel is lower than the wind noise decibel when the inclination angle α is 20°. Therefore, based on the effects shown in FIG. 8, it indicates that the larger the inclination angle α of the extension direction of the at least a portion of the hole section of the sound pickup hole 213 relative to the thickness direction Y, the better the reduction effect of the wind noise of the sound pickup hole 213.

If the inclination angle α of the extension direction of all hole section of the sound pickup hole 213 relative to the thickness direction Y is equal to 0° (i.e., the extension direction of the connection line between the center of the sound input end 2132 and the center of the sound output end 2131 is parallel to the thickness direction Y), when an external airflow flows over the core housing 210, an airflow component along the thickness direction Y may directly pass through the sound pickup hole 213 and vertically impact the microphone 220, thereby generating significant wind noise and reducing the sound pickup effect of the microphone 220.

When the inclination angle α of the extension direction of the at least a portion of the hole section of the sound pickup hole 213 relative to the thickness direction Y is greater than 40°, a blocking effect of the hole wall of the sound pickup hole 213 on the airflow is strong. However, the sound pickup hole 213 may also occupy a large space in the core housing 210, and an excessively large inclination angle α is not conducive to the machining of the sound pickup hole 213, thereby increasing the manufacturing complexity of the earphone 1. Moreover, the large inclination angle α of the sound pickup hole 213 may further result in a longer length of the sound pickup hole 213, thereby excessively attenuating the effective sound information entering the sound pickup hole 213.

The inclination angle α is set to be greater than 0° and less than or equal to 40° can facilitate the anti-wind-noise effect of the sound pickup hole 213 while reducing the machining difficulty of the sound pickup hole 213, reducing the space occupied by the sound pickup hole 213, and avoiding attenuation of the collection of the effective sound information. For example, the inclination angle α of the extension direction of the at least a portion of the hole section of the sound pickup hole 213 relative to the thickness direction Y may be 5°, 23°, 30°, 40°, or the like.

In some embodiments, the inclination angle α may be in a range of 10° to 30°. The inclination angle α is set to be in the range of 10° to 30° can ensure the anti-wind-noise effect of the sound pickup hole 213 while reducing the machining difficulty of the sound pickup hole 213, reducing the space occupied by the sound pickup hole 213, and preserving more effective sound information. Merely by way of example, the inclination angle α may be 10°, 12°, 15°, 18°, 20°, 25°, or the like.

In some embodiments, a count of the sound pickup hole 213 may correspond to a count of the microphone 220. That is, one microphone 220 corresponds to one sound pickup hole 213, and one microphone 220 collects external sound only through one sound pickup hole 213. Such an arrangement can reduce wind noise caused by airflow circulating in a plurality of sound pickup holes 213, thereby improving the sound pickup effect of the microphone 220 and reducing the machining difficulty of the core housing 210.

Merely by way of example, the sound producer 20 may have the plurality of sound pickup holes 213 and a plurality of microphones 220. For example, the sound producer 20 includes two microphones 220 and two sound pickup holes 213. The two microphones 220 and the two sound pickup holes 213 are arranged in a one-to-one correspondence, ensuring that one microphone 220 collects external sound only through one sound pickup hole 213.

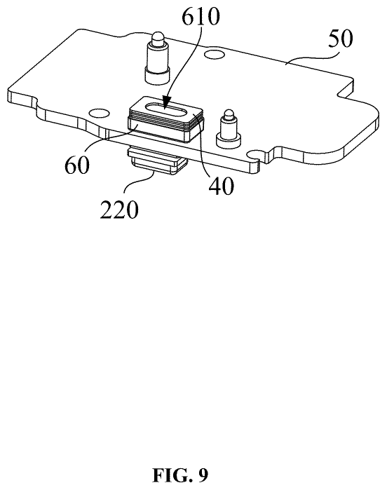

In some embodiments, as shown in FIG. 7 and FIG. 9, the earphone 1 may further include a composite sound resistance mesh 40 disposed between the sound output end 2131 of the sound pickup hole 213 and the microphone 220. The composite sound resistance mesh 40 may include at least two sub sound resistance meshes 410 stacked and spaced apart from each other. Sound input through the sound pickup hole 213 sequentially passes through the at least two sub sound resistance meshes 410 and then is input to the microphone 220.

Specifically, disposing the composite sound resistance mesh 40 between the sound output end 2131 of the sound pickup hole 213 and the microphone 220 can enable the composite sound resistance mesh 40 to further reduce wind noise after the airflow flows out from the sound output end 2131 of the sound pickup hole 213, thereby increasing the anti-wind-noise effect and improving the sound pickup effect of the microphone 220. In some embodiments, the sub sound resistance mesh 410 may be a combination of a steel mesh and a gauze mesh, or may be all gauze meshes or all steel meshes.

In some embodiments, the composite sound resistance mesh includes two sub sound resistance meshes 410. The two sub sound resistance meshes 410 can not only enhance the anti-wind-noise effect but also reduce attenuation of the effective sound information, enabling the microphone 220 to collect relatively clear sound, thereby improving the sound pickup effect, meanwhile avoiding increasing the thickness of the core housing 210 and reducing excessive space occupation.

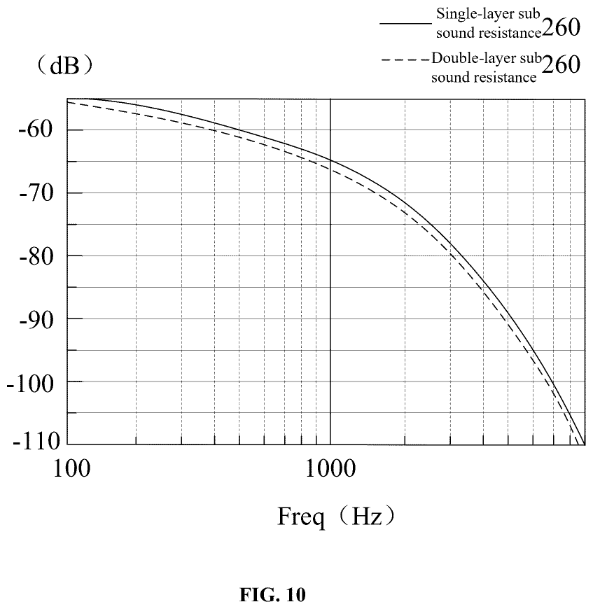

As shown in FIG. 10, FIG. 10 shows a comparison of effects between an arrangement of a double-layer sub sound resistance mesh 410 and an arrangement of a single-layer sub sound resistance mesh 410 under the same conditions, where all performance parameters of the sub sound resistance meshes 410 are the same. As shown in FIG. 10, when the double-layer sub sound resistance mesh 410 is provided between the sound output end 2131 and the microphone 220, a wind noise decibel of the sound collected by the microphone 220 is lower than a wind noise decibel when the single-layer sub sound resistance mesh 410 is provided. It indicates that the anti-wind-noise effect of providing the double-layer sub sound resistance mesh 410 is better than the anti-wind-noise effect of providing the single-layer sub sound resistance mesh 410.

In some embodiments, to improve the anti-wind-noise capability of the earphone 1, e.g., when the user uses the earphone 1 on a windy day or in harsh weather conditions, the count of the sub sound resistance meshes 410 may also be three, four, or five. The embodiment does not impose specific limitations herein.

In some embodiments, a spacing distance between adjacent sub sound resistance meshes 410 may be in a range of 0.05 mm to 0.3 mm. If the spacing distance between the adjacent sub sound resistance meshes 410 is less than 0.05 mm, the manufacturing complexity and the connection difficulty of the sub sound resistance meshes 410 may be increased. If the spacing distance between the adjacent sub sound resistance meshes 410 is greater than 0.3 mm, this will enable the composite sound resistance mesh 40 to occupy a larger space, and the anti-wind-noise effect will also be affected. Therefore, the spacing distance between adjacent sub sound resistance meshes 410 set in the range of 0.05 mm to 0.3 mm reduces the space occupied by the composite sound resistance mesh 40, ensures the anti-wind-noise effect of the composite sound resistance mesh 40, and facilitates adding and manufacturing a plurality of layers of sub sound resistance meshes 410. Merely by way of example, the spacing distance between the adjacent sub sound resistance meshes 410 may be 0.05 mm, 0.1 mm, 0.15 mm, 0.2 mm, 0.25 mm, 0.3 mm, etc.

In some embodiments, the adjacent sub sound resistance meshes 410 are bonded together by adhesion. This arrangement facilitates controlling the spacing distance between the adjacent sub sound resistance meshes 410 within a range of 0.05 mm to 0.3 mm, further reduce the space occupied by the composite sound resistance mesh 40, facilitate adding and manufacturing the plurality of layers of sub sound resistance meshes 410, and ensure the connection strength between the plurality of layers of sub sound resistance meshes 410.

In some embodiments, a sound resistance of each of the at least two sub sound resistance meshes 410 is in a range of 200 MKS Rayls to 700 MKS Rayls. A magnitude of the sound resistance of the sub sound resistance mesh 410 may affect a velocity at which the airflow passes through the sub sound resistance mesh 410. The greater the sound resistance of the sub sound resistance mesh 410, the more significant the impact of the sub sound resistance mesh 410 on the velocity of the airflow, resulting in a slower velocity of the airflow passing through the sub sound resistance mesh 410. Correspondingly, the smaller the sound resistance of the sub sound resistance mesh 410, the smaller the impact of the sub sound resistance mesh 410 on the velocity of the airflow.

If the sound resistance of the sub sound resistance mesh 410 is less than 200 MKS Rayls, a blocking effect of the sub sound resistance mesh 410 on the airflow is small, thereby reducing the anti-wind-noise capability of the sub sound resistance mesh 410. If the sound resistance of the sub sound resistance mesh 410 is greater than 700 MKS Rayls, the sound resistance of the sub sound resistance mesh 410 is too large, thus effective sound information is significantly attenuated, thereby affecting the sound pickup effect of the microphone 220. Therefore, the sound resistance of the sub sound resistance mesh 410 is set in the range of 200 MKS Rayls to 700 MKS Rayls, so as to improve the anti-wind-noise effect of the sub sound resistance mesh 410 while reducing the attenuation of sound by the sub sound resistance mesh 410, therefore improving the sound pickup effect of the microphone 220.

Merely by way of example, the sound resistance of the sub sound resistance mesh 410 may be 200 MKS Rayls, 260 MKS Rayls, 370 MKS Rayls, 430 MKS Rayls, 660 MKS Rayls, etc.

In some embodiments, as shown in FIG. 7, a sound pickup area 221 of the microphone 220 is disposed closer to the connection end 211 than the sound output end 2131 of the sound pickup hole 213. The sound pickup area 221 and the sound output end 2131 are thus offset from each other in the length direction X and the thickness direction Y, then a corner is formed between the sound pickup area 221 and the sound output end 2131. This arrangement prevents an airflow from directly reaching the sound pickup area 221 of the microphone 220 after exiting the sound pickup hole 213 through the sound output end 2131, so as to reduce wind noise generated by the airflow directly impacting the sound pickup area 221 of the microphone 220, thereby improving the anti-wind-noise effect.

In some embodiments, along the length direction X, a spacing distance between the sound pickup area 221 of the microphone 220 and the sound output end 2131 of the sound pickup hole 213 is in a range of 2 mm to 3 mm. The spacing distance between the sound pickup area 221 of the microphone 220 and the sound output end 2131 of the sound pickup hole 213 refers to a distance from a center position of the sound pickup area 221 to a hole center position of the sound output end 2131. The spacing distance between the sound pickup area 221 and the sound output end 2131 is shown as a distance d in FIG. 7. If the spacing distance between the sound pickup area 221 of the microphone 220 and the sound output end 2131 of the sound pickup hole 213 is greater than 3 mm, a space between the microphone 220 and the sound pickup hole 213 is large, thus a larger space in the core housing 210 is occupied, a sound wave transmission path is lengthened, and a loss of effective sound information is increased. If the spacing distance between the sound pickup area 221 of the microphone 220 and the sound output end 2131 of the sound pickup hole 213 is less than 2 mm, the distance between the sound pickup area 221 of the microphone 220 and the sound output end 2131 of the sound pickup hole 213 is too small, thus the airflow exiting from the sound output end 2131 easily directly impacts the sound pickup area 221 of the microphone 220, thereby causing a poor anti-wind-noise effect.

Setting the spacing distance between the sound pickup area 221 of the microphone 220 and the sound output end 2131 of the sound pickup hole 213 in the range of 2 mm to 3 mm can enhance the anti-wind-noise effect, avoid an excessive loss of effective sound information, and reduce space occupied between the microphone 220 and the sound pickup hole 213, thereby reducing a dimension of the core housing 210 in the length direction X.

Merely by way of example, the spacing distance between the sound pickup area 221 of the microphone 220 and the sound output end 2131 of the sound pickup hole 213 is set to 2 mm, 2.3 mm, 2.5 mm, 2.7 mm, or 3 mm, etc.

In some embodiments, as shown in FIG. 7, an inner wall of the core housing 210 has an annular partition plate 216, the annular partition plate 216 surrounds to form a connecting groove 2161, and the sound pickup hole 213 communicates with the connecting groove 2161.

As shown in FIG. 7 and FIG. 9, the earphone 1 includes a circuit board 50 and a sound guiding seat 60. The circuit board 50 and the sound guiding seat 60 are both installed in the core housing 210. The sound guiding seat 60 is disposed opposite to and coaxial with the connecting groove 2161. The sound guiding seat 60 is disposed on a side of the circuit board 50 facing the connecting groove 2161 and is provided with a sound guiding channel 610. The sound guiding seat 60 is embedded in the connecting groove 2161 under a supporting effect of the circuit board 50 and presses the composite sound resistance mesh 40 between the sound guiding seat 60 and the core housing 210. The microphone 220 is disposed on another side of the circuit board 50 away from the connecting groove 2161, a connecting hole 510 is provided on the circuit board 50, and the sound pickup area 221 of the microphone 220 communicates with the sound pickup hole 213 through the connecting hole 510 and the sound guiding channel 610. This arrangement allows the annular partition plate 216 and the sound guiding seat 60 to provide a limiting and fixing effect on the composite sound resistance mesh 40. Shifting of the composite sound resistance mesh 40 during installation is prevented, thereby ensuring the anti-wind-noise effect of the earphone 1.

In some embodiments, the circuit board 50 and the annular partition plate 216 abut or connect to each other, thereby enabling at least a portion of the sound guiding seat 60 to extend into the connecting groove 2161. To prevent loss of effective sound information due to sound wave dispersion, a sealing gasket (not shown in the figures) is further disposed between the sound guiding seat 60 and the circuit board 50. In some embodiments, the circuit board 50 and the annular partition plate 216 are connected by means such as adhesion, welding, snap-fit connection, screw connection, or sealing connection.

In some embodiments, as shown in FIG. 2, the core housing 210 may include a first housing 217 and a second housing 218. The first housing 217 and the second housing 218 are fitted to each other along the thickness direction Y and form a first joint seam 201. In the wearing state, the first housing 217 is farther from the auricle 103 than the second housing 218.

In some embodiments, as shown in FIG. 2, the ear hook 10 includes a transition portion 110, the transition portion 110 is connected to the second housing 218 and forms a second joint seam 202. At least one mounting slot 2171 in an elongated shape is provided on an outer surface of the second housing 218. The first joint seam 201, a major axis direction of the at least one mounting slot 2171, and the second joint seam 202 are inclined in the same direction relative to the length direction X.

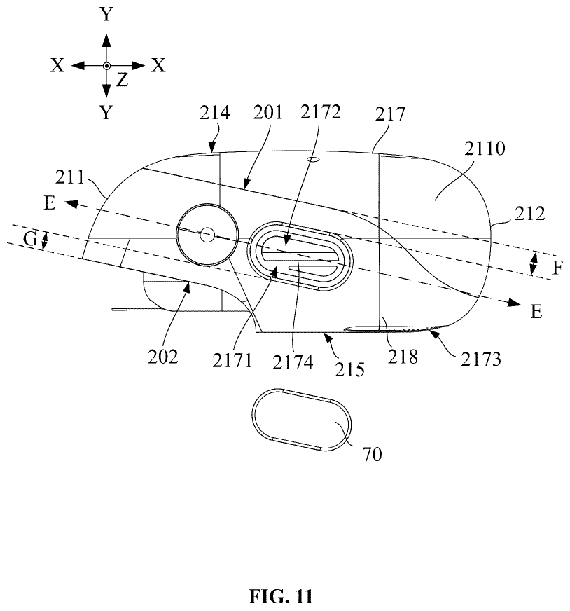

In some embodiments, the first joint seam 201 may be at least a portion of a mold parting seam between the first housing 217 and the second housing 218. The second joint seam 202 may be at least a portion of a mold parting seam between the transition portion 110 of the ear hook 10 and the second housing 218. The major axis direction of the mounting slot 2171 refers to an extension direction along a length direction of the mounting slot 2171 in the elongated shape. The major axis direction of the mounting slot 2171 is shown as a direction indicated by a direction of an arrow E in FIG. 11.

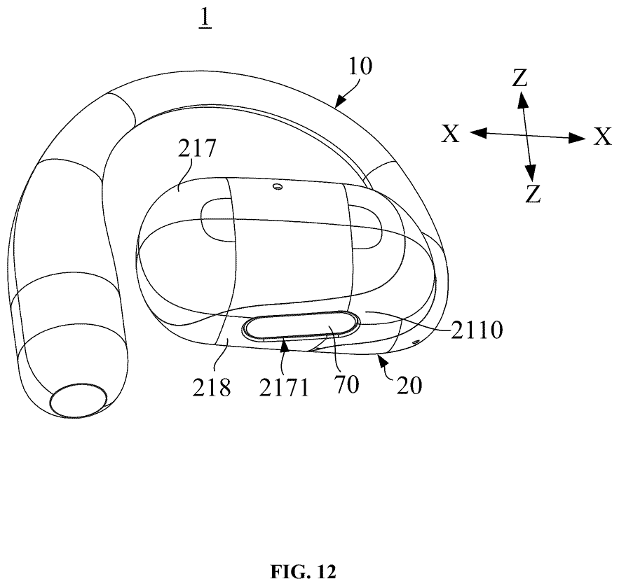

In some embodiments, as shown in FIG. 2, FIG. 11, and FIG. 12, the core housing 210 includes a third sidewall 219 and a fourth sidewall 2110. The third sidewall 219 and the fourth sidewall 2110 are spaced apart along the width direction Z. The third sidewall 219 is connected to the first sidewall 214 and the second sidewall 215 along the thickness direction Y. The fourth sidewall 2110 is connected to the first sidewall 214 and the second sidewall 215 along the thickness direction Y. The first joint seam 201 refers to a portion of the mold parting seam between the first housing 217 and the second housing 218 located on the third sidewall 219. The second joint seam 202 is a portion of the mold parting seam between the transition portion 110 and the second housing 218 located on the third sidewall 219.

The first joint seam 201, the major axis direction of the mounting slot 2171, and the second joint seam 202 being inclined in the same direction relative to the length direction X means that the first joint seam 201, the major axis direction of the mounting slot 2171, and the second joint seam 202 are all inclined relative to the length direction X, and their inclination angles are the same or differ by no more than 5°. This arrangement allows the first housing 217, the second housing 218, and the transition portion 110 of the ear hook 10 to mutually support each other, thereby improving the strength of the second housing 218 at the mounting slot 2171 and improving the strength of the core housing 210. Furthermore, the parallel arrangement of the first joint seam 201 and the second joint seam 202 eliminates the need to adjust an installation direction to align the first housing 217 and the second housing 218 during installation, thereby reducing the installation steps and improving the installation efficiency. The parallel and similarly inclined arrangement of the first joint seam 201, the major axis direction of the mounting slot 2171, and the second joint seam 202 also improves the aesthetic appearance of the earphone 1.

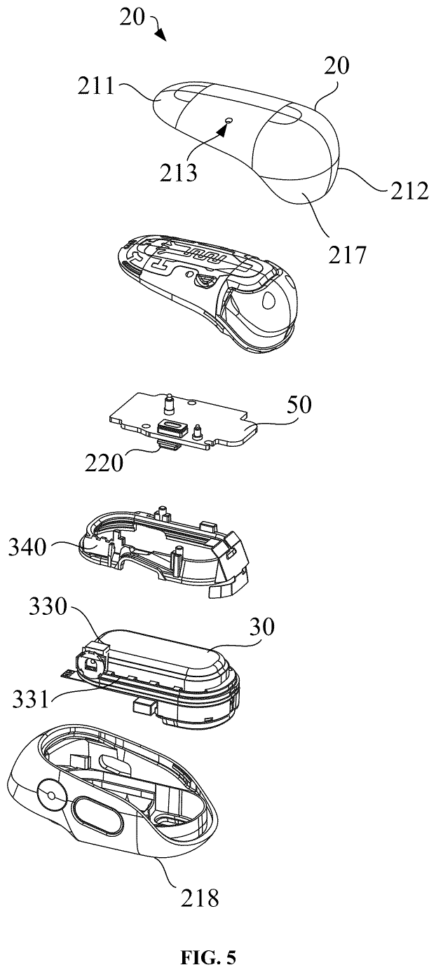

In some embodiments, as shown in FIG. 5, FIG. 6, and FIG. 11, the earphone 1 includes the speaker assembly 30 disposed inside the core housing 210, the speaker assembly 30 and the core housing 210 form an acoustic front cavity 310 and an acoustic rear cavity 320. The speaker assembly 30 includes a speaker 330. The speaker 330 may be an air conduction speaker. The speaker 330 includes a diaphragm 321, the diaphragm 321 separates the acoustic front cavity 310 and the acoustic rear cavity 320.

The second housing 218 may include a sound output hole 2173, and the acoustic front cavity 310 is in communication with the sound output hole 2173. Sound generated by a front side of the diaphragm 321 is transmitted to an outside through the acoustic front cavity 310 and the sound output hole 2173. In some embodiments, a pressure relief hole 2172 is further provided on the second housing and located in the at least one mounting slot 2171, and the pressure relief hole 2172 communicates the acoustic rear cavity 320 with the outside of the core housing 210. This allows air pushed by a rear side of the diaphragm 321 to flow from the acoustic rear cavity 320 to the outside of the core housing 210, thus, a pressure buildup in the acoustic rear cavity 320 can be minimized, thereby ensuring the sound quality of the speaker assembly 30.

In some embodiments, as shown in FIG. 11, an acoustic mesh 70 may be disposed in the at least one mounting slot 2171 and cover the pressure relief hole 2172. Specifically, the acoustic mesh 70 is disposed on a side of the pressure relief hole 2172 facing away from the interior of the core housing 210. The acoustic mesh 70 is exposed on the outer surface of the core housing 210. The acoustic mesh 70 is configured to isolate dust, particles, water droplets, or the like in the air, preventing them from easily entering the acoustic rear cavity 320, thereby reducing a corrosion degree or damage to the speaker assembly 30.

Merely by way of example, the acoustic mesh 70 may be an isolation cotton sheet, a gauze, a steel mesh, etc.

In some embodiments, a ratio of an area of the pressure relief hole 2172 to an area of the at least one mounting slot 2171 may be in a range of 0.2 to 0.7. The area of the at least one mounting slot 2171 refers to an area of the at least one mounting slot 2171 in the elongated shape. If the ratio of the area of the pressure relief hole 2172 to the area of the at least one mounting slot 2171 is less than 0.2, it indicates that the area of the pressure relief hole 2172 is too small or the area of the at least one mounting slot 2171 is too large. An excessively small area of the pressure relief hole 2172 leads to poor pressure relief effect for the acoustic rear cavity 320, thereby affecting the sound quality of the speaker assembly 30. An excessively large area of the at least one mounting slot 2171 increases an overall size of the earphone 1, thereby affecting wearing comfort. If the ratio of the area of the pressure relief hole 2172 to the area of the mounting slot 2171 is greater than 0.7, it indicates that the pressure relief hole 2172 occupies too much area within the at least one mounting slot 2171, thereby making it difficult to install the acoustic mesh 70 in the at least one mounting slot 2171. Therefore, setting the ratio of the area of the pressure relief hole 2172 to the area of the mounting slot 2171 in the range of 0.2 to 0.7 can enhance the pressure relief effect for the acoustic rear cavity 320 while also facilitating installation of the acoustic mesh 70 in the at least one mounting slot 2171, thereby reducing assembly difficulty of the earphone 1.

Merely by way of example, the ratio of the area of the pressure relief hole 2172 to the area of the at least one mounting slot 2171 may be set to 0.2, 0.3, 0.4, 0.5, 0.6, or the like.

In some embodiments, a minimum spacing distance between a slot edge of the at least one mounting slot 2171 and the first joint seam 201 may be in a range of 1 mm to 2 mm, and/or a minimum spacing distance between the slot edge of the at least one mounting slot 2171 and the second joint seam 202 may be in a range of 1 mm to 2 mm.

The minimum spacing distance between the slot edge of the at least one mounting slot 2171 and the first joint seam 201 is shown as distance F in FIG. 11. The minimum spacing distance between the slot edge of the at least one mounting slot 2171 and the second joint seam 202 is shown as distance G in FIG. 11.

If the minimum spacing distance between the slot edge of the at least one mounting slot 2171 and the first joint seam 201 or the minimum spacing distance between the slot edge of the at least one mounting slot 2171 and the second joint seam 202 is less than 1 mm, it indicates that the at least one mounting slot 2171 is too close to an edge of the second housing 218, this makes it difficult to form the at least one mounting slot 2171 on the second housing 218, thereby increasing the manufacturing complexity of the earphone 1 and affecting structural strength of the core housing 210. If the minimum spacing distance between the slot edge of the at least one mounting slot 2171 and the first joint seam 201 or the minimum spacing distance between the slot edge of the at least one mounting slot 2171 and the second joint seam 202 is greater than 2 mm, it indicates that a machining space for the at least one mounting slot 2171 is too small. An excessively small machining space for the at least one mounting slot 2171 affects the size of the pressure relief hole 2172, and this will affect the pressure relief effect of the pressure relief hole 2172 for the acoustic rear cavity 320. Alternatively, it may indicate that the second housing 218 is too large, which may affect the size of the sound producer 20 of the earphone 1.

Therefore, setting the minimum spacing distance between the slot edge of the at least one mounting slot 2171 and the first joint seam 201 or the minimum spacing distance between the slot edge of the at least one mounting slot 2171 and the second joint seam 202 in the range of 1 mm to 2 mm facilitates a formation of the at least one mounting slot 2171 on the second housing 218, thereby reducing the manufacturing complexity of the earphone 1, ensuring the pressure relief effect of the pressure relief hole 2172 for the acoustic rear cavity 320, and reducing the size of the sound producer 20 of the earphone 1.

In some embodiments, the minimum spacing distance between the slot edge of the at least one mounting slot 2171 and the first joint seam 201, and the minimum spacing distance between the slot edge of the at least one mounting slot 2171 and the second joint seam 202 may both be in the range of 1 mm to 2 mm.

Merely by way of example, the minimum spacing distance between the slot edge of the at least one mounting slot 2171 and the first joint seam 201 or the minimum spacing distance between the slot edge of the at least one mounting slot 2171 and the second joint seam 202 may be 1 mm, 1.32 mm, 1.66 mm, 1.82 mm, or the like. Alternatively, the minimum spacing distance between the slot edge of the at least one mounting slot 2171 and the first joint seam 201 and the minimum spacing distance between the slot edge of the at least one mounting slot 2171 and the second joint seam 202 may both be 1 mm, 1.32 mm, 1.66 mm, 1.82 mm, or the like.

In some embodiments, as shown in FIG. 11, the first housing 217 may include the first sidewall 214, and the second housing 218 may include the second sidewall 215. The first sidewall 214 and the second sidewall 215 are spaced apart along the thickness direction Y. The second sidewall 215 is closer to the auricle 103 than the first sidewall 214 in the wearing state.

In some embodiments, the first joint seam 201, the major axis direction of the at least one mounting slot 2171, and the second joint seam 202 may all gradually be away from the second sidewall 215 in a direction from the free end 212 toward the connection end 211. In other words, ends of the first joint seam 201, the at least one mounting slot 2171, and the second joint seam 202 near the free end 212 are farther from the first sidewall 214. Ends of the first joint seam 201, the at least one mounting slot 2171, and the second joint seam 202 away from the free end 212 are closer to the first sidewall 214.

When the earphone 1 is worn on the ear 100 of the user, and the user touches the earphone 1 to perform an operation, the free end 212 and the first sidewall 214 near the free end 212 are most likely to be touched. Therefore, by configuring the at least one mounting slot 2171 such that its end near the free end 212 is kept away from the first sidewall 214, users are less likely to cover the at least one mounting slot 2171 when touching the sound producer 20. This reduces the risk of blocking the pressure relief hole 2172, thereby helping to ensure the pressure relief effect of the pressure relief hole 2172 for the acoustic rear cavity 320.

In some embodiments, referring to FIG. 5, FIG. 6, and FIG. 11, the speaker assembly 30 may include a voice coil support 340, and the speaker 330 includes an annular platform surface 331. The voice coil support 340 is supported on the annular platform surface 331 and cooperates with the speaker 330 to form the acoustic rear cavity 320. When viewed along the width direction Z, a hole edge of the pressure relief hole 2172 has an edge straight segment 2174. The edge straight segment 2174 and the annular platform surface 331 are flush with or parallel to each other. Configuring the hole edge of the pressure relief hole 2172 to cooperate with the annular platform surface 331 ensures that the pressure relief hole 2172 avoids the annular platform surface 331, thereby reducing an invalid area of the pressure relief hole 2172 and improving space utilization.

In some embodiments, a count of the at least one mounting slot 2171 and a count of the pressure relief hole 2172 may be a plurality. The count of the at least one mounting slot 2171 corresponds to the count of the pressure relief hole 2172. That is, one pressure relief hole 2172 is disposed in one mounting slot 2171.

Merely by way of example, referring to FIG. 3 and FIG. 12, the count of the at least one mounting slot 2171 may be two. Two mounting slots 2171 are both disposed on the second housing 218 and are spaced apart along the width direction Z. A slot wall of each of the two mounting slots 2171 is correspondingly provided with the pressure relief hole 2172. Two pressure relief holes 2172 may both communicate with the acoustic rear cavity 320. A count of the acoustic mesh 70 may also be two. Two acoustic meshes 70 are respectively installed in the two mounting slots 2171.

In some embodiments, a plurality of pressure relief holes 2172 may also be provided in one mounting slot 2171. For example, two pressure relief holes 2172 or three pressure relief holes 2172 may be provided in one mounting slot 2171. Such an arrangement can satisfy higher pressure relief requirements, thereby more effectively preventing pressure buildup in the acoustic rear cavity 320 and further improving the sound quality of the speaker assembly 30.

In summary, the earphone 1 described in the present disclosure includes the core housing 210. The core housing 210 includes the free end 212 and the connection end 211. In the wearing state, the connection end 211 of the earphone 1 is closer to the mouth of the user than the free end 212. Therefore, when the user moves forward, such as walking, running, or cycling, the airflow near the earphone 1 typically flows from the connection end 211 toward the free end 212. Therefore, the sound input end 2132 of the sound pickup hole 213 is disposed closer to the free end 212 than the sound output end 2131 of the sound pickup hole 213. Furthermore, the connecting line between the sound output end 2131 and the sound input end 2132 of the sound pickup hole 213 may intersect the sagittal axis of the human body and form an acute angle with the sagittal axis in the direction from the front of the human body toward the rear of the human body. Simultaneously, the sound output end 2131 is closer to the sagittal axis of the human body than the sound input end 2132. This causes the sound pickup hole 213 to be inclined toward the rear side of the head of the user relative to the side of the mouth of the user. When an airflow flowing from the connection end 211 toward the free end 212 enters the sound pickup hole 213 at the sound input end 2132, the airflow is first blocked by the hole wall of the sound pickup hole 213 before further entering the sound pickup hole 213, and then flows toward the sound output end 2131. The blocking of the airflow by the hole wall of the sound pickup hole 213 prevents the airflow from flowing directly toward the sound output end 2131. The impact degree of the airflow on the microphone 220 is reduced during the blocking process by the hole wall of the sound pickup hole 213. Therefore, disposing the sound input end 2132 of the sound pickup hole 213 closer to the free end 212 than the sound output end 2131 can reduce the impact force of the airflow on the microphone 220 in the wearing state, thereby improving the anti-wind-noise capability of the earphone 1 and effectively enhancing the sound pickup effect of the microphone 220.

The foregoing embodiments are merely used to illustrate the technical solutions of the present disclosure, and are not intended to limit the scope of the present disclosure. Any equivalent structure or equivalent process transformation made based on the content of the specification and drawings of the present disclosure, or any direct or indirect application in other related technical fields, is similarly included within the scope of patent protection of the present disclosure

1. An earphone, comprising: an ear hook and a sound producer connected to each other, wherein the ear hook is hung between an auricle and the head of a user, the sound producer is located at a front side of the auricle, the sound producer includes a core housing and a microphone, the ear hook is connected to the core housing, the microphone is disposed inside the core housing, the core housing has a connection end connected to the ear hook and a free end away from the connection end, in a wearing state, the connection end is closer to the mouth of the user than the free end, a sound pickup hole is formed on the core housing and located between the free end and the connection end, the microphone collects sound outside the earphone through the sound pickup hole, and a sound output end of the sound pickup hole is disposed closer to the connection end than a sound input end of the sound pickup hole.

2. The earphone according to claim 1, wherein the core housing has a length direction and a thickness direction orthogonal to each other, the length direction is an interval direction between the connection end and the free end, the thickness direction is a direction toward or away from the auricle in the wearing state, and at least a portion of a hole section of the sound pickup hole is inclined relative to the length direction and the thickness direction.

3. The earphone according to claim 2, wherein the core housing includes a first sidewall and a second sidewall spaced apart along the thickness direction, the second sidewall is closer to the auricle than the first sidewall in the wearing state, the sound pickup hole is disposed on the first sidewall, and an extension direction of at least a portion of the hole section of the sound pickup hole has an inclination angle relative to the thickness direction greater than 0° and less than or equal to 40°.

4. The earphone according to claim 3, wherein a count of the sound pickup hole corresponds to a count of the microphone, along an extension direction of a line connecting a center of the sound output end and a center of the sound input end, a cross-sectional area of the sound pickup hole is uniform, and the inclination angle is in a range of 10° to 30°.

5. The earphone according to claim 1, further comprising a composite sound resistance mesh disposed between the sound output end of the sound pickup hole and the microphone, wherein the composite sound resistance mesh includes at least two sub sound resistance meshes stacked and spaced apart from each other, and sound input through the sound pickup hole sequentially passes through the at least two sub sound resistance meshes and then is input to the microphone.

6. The earphone according to claim 5, wherein a spacing distance between adjacent sub sound resistance meshes is in a range of 0.05 mm to 0.3 mm, and/or, a sound resistance of each of the at least two sub sound resistance meshes is in a range of 200 MKS Rayls to 700 MKS Rayls.

7. The earphone according to claim 1, wherein a count of the sound pickup hole corresponds to a count of the microphone, and a sound pickup area of the microphone is disposed closer to the connection end than the sound output end of the sound pickup hole.

8. The earphone according to claim 2, wherein along the length direction, a spacing distance between a sound pickup area of the microphone and the sound output end of the sound pickup hole is in a range of 2 mm to 3 mm.

9. The earphone according to claim 5, wherein an inner wall of the core housing has an annular partition plate, the annular partition plate surrounds to form a connecting groove, and the sound pickup hole communicates with the connecting groove;
the earphone comprises a circuit board and a sound guiding seat, the sound guiding seat is disposed on a side of the circuit board facing the connecting groove and is provided with a sound guiding channel, the sound guiding seat is embedded in the connecting groove under a supporting effect of the circuit board and presses the composite sound resistance mesh between the sound guiding seat and the core housing, the microphone is disposed on another side of the circuit board away from the connecting groove, a connecting hole is provided on the circuit board, and the microphone communicates with the sound pickup hole through the connecting hole and the sound guiding channel.

10. The earphone according to claim 1, wherein the core housing has a length direction, a thickness direction, and a width direction orthogonal to each other, the length direction is an interval direction between the connection end and the free end, the thickness direction is a direction toward or away from the auricle in the wearing state, the core housing includes a first housing and a second housing, the first housing and the second housing are fitted to each other along the thickness direction and form a first joint seam, in the wearing state, the first housing is farther from the auricle than the second housing, the ear hook includes a transition portion, the transition portion is connected to the second housing and forms a second joint seam, at least one mounting slot in an elongated shape is provided on an outer surface of the second housing, and the first joint seam, a major axis direction of the at least one mounting slot, and the second joint seam are inclined in a same direction relative to the length direction.

11. The earphone according to claim 10, wherein the first housing has a first sidewall, the second housing has a second sidewall, the first sidewall and the second sidewall are spaced apart along the thickness direction, the second sidewall is closer to the auricle than the first sidewall in the wearing state, and the first joint seam, the major axis direction of the at least one mounting slot, and the second joint seam are gradually away from the second sidewall along a direction from the free end toward the connection end.

12. The earphone according to claim 10, wherein a minimum spacing distance between a slot edge of the at least one mounting slot and the first joint seam is in a range of 1 mm to 2 mm; and/or a minimum spacing distance between the slot edge of the at least one mounting slot and the second joint seam is in a range of 1 mm to 2 mm.

13. The earphone according to claim 10, further comprising a speaker assembly disposed inside the core housing, wherein the speaker assembly and the core housing form an acoustic front cavity and an acoustic rear cavity, a pressure relief hole is further provided on the second housing and located in the at least one mounting slot, the pressure relief hole communicates with the acoustic rear cavity, an acoustic mesh is disposed in the at least one mounting slot and covers the pressure relief hole, and a ratio of an area of the pressure relief hole to an area of the at least one mounting slot is in a range of 0.2 to 0.7.
